(19) United States
(12) Patent Application Publication
(10) Pub. No.: US 2010/0257118 A1
(43) Pub. Date: Oct. 7, 2010

(54) VOLATILITY INDEX AND DERIVATIVE CONTRACTS BASED THEREON

(75) Inventors: William Speth, Evanston, IL (US); Joseph Levin, Northbrook, IL (US); Sandy Rattray, London (GB); Devesh Shah, New York, NY (US)

Correspondence Address: BRINKS HOFER GILSON & LIONE, P.O. BOX 10395, CHICAGO, IL, 60610, US

(73) Assignee: Chicago Board Options Exchange, Incorporated

(21) Appl. No.: 12/632,560

(22) Filed: Dec. 7, 2009

Related U.S. Application Data
(63) Continuation of application No. 10/959,528, filed on Oct. 6, 2004, now abandoned.
(60) Provisional application No. 60/519,131, filed on Nov. 12, 2003.

(51) Int. Cl. G06Q 40/00

(52) U.S. Cl. 705/36 R

(57) ABSTRACT

An improved volatility index and related futures contracts are provided. An index in accordance with the principals of the present invention estimates expected volatility from the prices of stock index options in a wide range of strike prices, not just at-the-money strikes. Also, an index in accordance with the principals of the present invention is not calculated from the Black/Scholes or any other option pricing model: the index of the present invention uses a newly developed formula to derive expected volatility by averaging the weighted prices of out-of-the money put and call options. In accordance with another aspect of the present invention, derivative contracts such as futures and options based on the volatility index of the present invention are provided.

### CROSS-REFERENCE TO RELATED APPLICATIONS

This application is a continuation of U.S. application Ser. No. 10/959,528 filed Oct. 6, 2004, pending, the entirety of which is incorporated herein by reference, which claims the benefit of U.S. Provisional App. No. 60/519,131 titled, “Volatility Index And Derivative Contracts Based Thereon” filed Nov. 12, 2003.

### BACKGROUND OF THE INVENTION

### Field of the Invention

The present invention relates to financial indexes and derivative contracts based thereon.

In 1993, the Chicago Board Options Exchangeo, 400 South LaSalle Street, Chicago, Ill. 60605 (“CBOE®”) introduced the CBOE Volatility Index®, (“VIX®”). The prior art VIX® index quickly became the benchmark for stock market volatility. The prior art Vix® index is widely followed and has been cited in hundreds of news articles in leading financial publications such as the Wall Street Journal and Barron's, both published by Dow Jones & Company, World Financial Center, 200 Liberty Street, New York, N.Y. 10281. The prior art VIX® index measures market expectations of near term volatility conveyed by stock index option prices. Since volatility often signifies financial turmoil, the prior art VIX® index is often referred to as the “investor fear gauge”.

The prior art VIX® index provides a minute-by-minute snapshot of expected stock market volatility over the next 30 calendar days. This implied volatility is calculated in real-time from stock index option prices and is continuously disseminated throughout the trading day; however, the expected volatility estimates of the prior art Vix® index is derived from a limited number of options, the just at-the-money strikes. Also, the prior art Vix® index is dependent on an option pricing model, particularly the Black/Scholes option pricing model. (Black, Fischer and Scholes, Myron, The Pricing of Options and Corporate Liabilities, Journal of Political Economy 81, 637-659 (1973)). Still further, the prior art VIX® index uses a relatively limited sampling of stocks, particularly, the prior art VIX® is calculated using options based on the S&P 100® index, which is a relatively limited representation of the stock market. The S&P 100® index is disseminated by Standard & Poor's, 55 Water Street, New York, N.Y. 10041 (“S&P”).

What would thus be desirable would be an improved volatility index that is derived from a broader sampling than just at-the-money strikes. An improved volatility index would be independent from the Black/Scholes option pricing model, and would preferably be independent from any pricing model. Still further, an improved volatility index would be derived from a broader sampling than options from the S&P 100® index.

### SUMMARY OF THE INVENTION

An index in accordance with the principals of the present invention is derived from a broader sampling than just at-the-money strikes. An index in accordance with the principals of the present invention is independent from the Black/Scholes or any other option pricing model. An index in accordance with the principals of the present invention is derived from a broader sampling than options from the S&P 100® index.

In accordance with the principals of the present invention, an improved volatility index is provided. The index of the present invention estimates expected volatility from options covering a wide range of strike prices, not just at-the-money strikes as in the prior art VIX® index. Also, the index of the present invention is not calculated from the Black/Scholes or any other option pricing model: the index of the present invention uses a newly developed formula to derive expected volatility by averaging the weighted prices of out-of-the money put and call options. Further, the index of the present invention uses a broader sampling than the prior art VIXO index. In accordance with another aspect of the present invention, derivative contracts based on the volatility index of the present invention are provided.

### BRIEF DESCRIPTION OF THE DRAWING

FIG. 1 is a graph illustrating the prior art VIXO index, the S&P 500® index, and an example index in accordance with the principals of the present invention from January 1998 through April 2003.

FIG. 2 is a graph illustrating the prior art VIXO index, the S&P 500® index, and the example index of FIG. 1 from 3 Aug. 1998 through 23 Nov. 1998.

FIG. 3 is a scatter plot comparing daily measurements from the prior art VIX® index and the example index of FIG. 1 against the S&P 500® index.

### DETAILED DESCRIPTION OF THE INVENTION

An index in accordance with the principals of the present invention estimates expected volatility from options covering a wide range of strike prices. Also, an index in accordance with the principals of the present invention is not calculated from the Black/Scholes or any other option pricing model: the index of the present invention uses a newly developed formula to derive expected volatility by averaging the weighted prices of out-of-the money put and call options. This simple and powerful derivation is based on theoretical results that have spurred the growth of a new market where risk managers and hedge funds can trade volatility, and market makers can hedge volatility trades with listed options.

An index in accordance with the principals of the present invention uses options on the S&P 500® index rather than the S&P 100® index. The S&P 500® index is likewise disseminated by Standard & Poors. While the two indexes are well correlated, the S&P 500® index is the primary U.S. stock market benchmark, is the reference point for the performance of many stock funds, and has over $900 billion in indexed assets. In addition, the S&P 500® index underlies the most active stock index derivatives, and it is the domestic index tracked by volatility and variance swaps.

With these improvements, the volatility index of the present invention measures expected volatility as financial theorists, risk managers, and volatility traders have come to understand volatility. As such, the volatility index calculation of the present invention more closely conforms to industry practice, is simpler, yet yields a more robust measure of expected volatility. The volatility index of the present invention is more robust because it pools the information from option prices over the whole volatility skew, not just at-the-money options. The volatility index of the present invention is based on a core index for U.S. equities, and the volatility index calculation of the present invention supplies a script for replicating volatility from a static strip of a core index for U.S. equities.

Another valuable feature of the volatility index of the present invention is the existence of historical prices from 1990 to the present. This extensive data set provides investors with a useful perspective of how option prices have behaved in response to a variety of market conditions.

As a first step, the options to be used in the volatility index of the present invention are selected. The volatility index of the present invention uses put and call options on the S&P 500® index. For each contract month, a forward index level is determined based on at-the-money option prices. The at-the-money strike is the strike price at which the difference between the call and put prices is smallest. The options selected are out-of-the-money call options that have a strike price greater than the forward index level and out-of-the-money put options that have a strike price less than the forward index level.

The forward index prices for the near and next term options are determined. Next, the strike price immediately below the forward index level is determined. Using only options that have non-zero bid prices, out-of-the-money put options with a strike price less then the strike price immediately below the forward index level and call options with a strike price greater than the strike price immediately below the forward index level are selected. In addition, both put and call options with strike prices equal to the strike price immediately below the forward index level are selected. Then the quoted bid-ask prices for each option are averaged.

Two options are selected at the strike price immediately below the forward index level, while a single option, either a put or a call, is used for every other strike price. This centers the options around the strike price immediately below the forward index level. In order to avoid double counting, however, the put and call prices at the strike price immediately below the forward index level are averaged to arrive at a single value.

As the second step, variance (σ²) for both near term and next term options are derived. Variance in the volatility index in accordance with the principles of the present invention is preferably derived from:

$${σ}^{2} = \frac{2}{T} {\sum }_{i} \frac{Δ {K}_{i}}{{K}_{i}^{2}} {e}^{RT} Q ( {K}_{i} ) - {\frac{1}{T} [ \frac{F}{{K}_{0}} - 1 ]}^{2}$$

where:

T is the time to expiration;

F is the forward index level derived from index option prices;

Kᵢ is the strike price of i^{th} out-of-the-money option—a call if Kᵢ>F and a put if Kᵢ<F;

ΔKᵢ is the interval between strike prices—half the distance between the strike on either side of Kᵢ:

$$Δ {K}_{i} = \frac{{K}_{i + 1} - {K}_{i - 1}}{2}$$

further where ΔK for the lowest strike is the difference between the lowest strike and the next higher strike; likewise, ΔK for the highest strike is the difference between the highest strike and the next lower strike;

K₀ is the first strike below the forward index level, F;

R is the risk-free interest rate to expiration; and

Q(Kᵢ) is the midpoint of the bid-ask spread for each option with strike Kᵢ.

An index in accordance with the present invention can preferably measure the time to expiration, T, in minutes rather than days in order to replicate the precision that is commonly used by professional option and volatility traders. The time to expiration in the volatility index in accordance with the principles of the present invention is preferably derived from the following:

$$T = \frac{\{ {M}_{Current day} + {M}_{Settlement day} + {M}_{Other days} \}}{Minutes in a year}$$

where:

M_{Current day} is the number of minutes remaining until midnight of the current day;

M_{Settlement day} is the number of minutes from midnight until the target time on the settlement day; and

M_{Other days} is the Total number of minutes in the days between current day and settlement day.

As the third step, the volatility is derived from the calculated variance. Initially, the near term σ² and the next term σ² are interpolated to arrive at a single value with a constant maturity to expiration. Then, the square root of this interpolated variance is calculated to derive the volatility (σ).

As known in the art, an index in accordance with the principals of the present invention is preferable embodied as a system cooperating with computer hardware components, and as a computer implemented method.

### Example Index

The following is a non-limiting illustrative example of the determination of a volatility index in accordance with the principles of the present invention.

First, the options to be used in the example volatility index of the present invention are selected. The example volatility index of the present invention generally uses put and call options in the two nearest-term expiration months in order to bracket a 30-day calendar period; however, with 8 days left to expiration, the example volatility index of the present invention “rolls” to the second and third contract months in order to minimize pricing anomalies that might occur close to expiration. The options used in the example volatility index of the present invention have 16 days and 44 days to expiration, respectively. The options selected are out-of-the-money call options that have a strike price greater than the forward index level, and out-of-the-money put options that have a strike price less than the forward index level. The risk-free interest rate is assumed to be 1.162%. While for simplicity in the example index the same number of options is used for each contract month and the interval between strike prices is uniform, there may be different options used in the near and next term and the interval between strike prices may be different.

For each contract month, the forward index level, F, is determined based on at-the-money option prices. As shown in Table 1, in the example volatility index the difference between the call and put prices is smallest at the 900 strike in both the near and next term:

TABLE 1
Differences between Call and Put Prices in the Example Index

| Near Term Options | | | | Next Term Options | | | |
|---|---|---|---|---|---|---|---|
| Strike | | | Differ- | Strike | | | |
| Price | Call | Put | ence | Price | Call | Put | Difference |
| 775 | 125.48 | 0.11 | 125.37 | 775 | 128.78 | 2.72 | 126.06 |
| 800 | 100.79 | 0.41 | 100.38 | 800 | 105.85 | 4.76 | 101.09 |
| 825 | 76.70 | 1.30 | 75.39 | 825 | 84.14 | 8.01 | 76.13 |
| 850 | 54.01 | 3.60 | 50.41 | 850 | 64.13 | 12.97 | 51.16 |
| 875 | 34.05 | 8.64 | 25.42 | 875 | 46.38 | 20.18 | 26.20 |
| 900 | 18.41 | 17.98 | 0.43 | 900 | 31.40 | 30.17 | 1.23 |
| 925 | 8.07 | 32.63 | 24.56 | 925 | 19.57 | 43.31 | 23.73 |
| 950 | 2.68 | 52.23 | 49.55 | 950 | 11.00 | 59.70 | 48.70 |
| 975 | 0.62 | 75.16 | 74.53 | 975 | 5.43 | 79.10 | 73.67 |
| 1000 | 0.09 | 99.61 | 99.52 | 1000 | 2.28 | 100.91 | 98.63 |
| 1025 | 0.01 | 124.52 | 124.51 | 1025 | 0.78 | 124.38 | 123.60 |

Using the 900 call and put in each contract month the following is used to derive the forward index prices,

F=Strike Price+e^{RT}×(Call Price−Put Price),

where R is the risk-free interest rate and T is the time to expiration. The time of the example index is assumed to be 8:30 a.m. (Chicago time). Therefore, with 8:30 a.m. as the time of the calculation for the example index, the time to expiration for the near-term and next-term options, T₁ and T₂, respectively, is:

T₁={930+510+20,160)/525,600=0.041095890

T₂={930+510+60,480)/525,600=0.117808219

The forward index prices, F₁ and F₂, for the near and next term options, respectively, are:

F₁=900+e^{(0.01162×0.041095890)}×(18.41−17.98)=900.43

F₂=900+e^{(0.01162×0117808219)}×(31.40−30.17)=901.23

Then, the strike price immediately below the forward index level (K₀) is determined. In this example, K₀=900 for both expirations.

Next, the options are sorted in ascending order by strike price. Call options that have strike prices greater than K₀ and a non-zero bid price are selected. After encountering two consecutive calls with a bid price of zero, no other calls are selected. Next, put options that have strike prices less than K₀ and a non-zero bid price are selected. After encountering two consecutive puts with a bid price of zero, no other puts are selected. Additionally, both the put and call with strike price K₀ are selected. Then the quoted bid-ask prices for each option are averaged. Two options are selected at K₀, while a single option, either a put or a call, is used for every other strike price. This centers the strip of options around K₀; however, in order to avoid double counting, the put and call prices at K₀ are averaged to arrive at a single value. The price used for the 900 strike in the near term is, therefore,

(18.41+17.98)/2=18.19;

and the price used in the next term is

(31.40+30.17)/2=30.78.

Table 2 contains the options used to calculate the example index:

TABLE 2
Options Used to Calculate the Example Index

| Near term | | Mid-quote | Next term | Option | Mid-quote |
|---|---|---|---|---|---|
| Strike | Option Type | Price | Strike | Type | Price |
| 775 | Put | 0.11 | 775 | Put | 2.72 |
| 800 | Put | 0.41 | 800 | Put | 4.76 |
| 825 | Put | 1.30 | 825 | Put | 8.01 |
| 850 | Put | 3.60 | 850 | Put | 12.97 |
| 875 | Put | 8.64 | 875 | Put | 20.18 |
| 900 | Put/Call | 18.19 | 900 | Put/Call | 30.78 |
| | Average | | | Average | |
| 925 | Call | 8.07 | 925 | Call | 19.57 |
| 950 | Call | 2.68 | 950 | Call | 11.00 |
| 975 | Call | 0.62 | 975 | Call | 5.43 |
| 1000 | Call | 0.09 | 1000 | Call | 2.28 |
| 1025 | Call | 0.01 | 1025 | Call | 0.78 |

Second, variance for both near term and next term options is calculated. Applying the generalized formula for calculating the example index to the near term and next term options with time of expiration of T₁ and T₂, respectively, yields:

$${σ}_{1}^{2} = \frac{2}{{T}_{1}} {\sum }_{i} \frac{Δ {K}_{i}}{{K}_{i}^{2}} {e}^{{RT}_{1}} Q ( {K}_{i} ) - {\frac{1}{{T}_{1}} [ \frac{{F}_{1}}{{K}_{0}} - 1 ]}^{2}$$

$${σ}_{2}^{2} = \frac{2}{{T}_{2}} {\sum }_{i} \frac{Δ {K}_{i}}{{K}_{i}^{2}} {e}^{{RT}_{2}} Q ( {K}_{i} ) - {\frac{1}{{T}_{2}} [ \frac{{F}_{2}}{{K}_{0}} - 1 ]}^{2}$$

The volatility index of the present invention is an amalgam of the information reflected in the prices of all of the options used. The contribution of a single option to the value of the volatility index of the present invention is proportional to the price of that option and inversely proportional to the square of the strike price of that option. For example, the contribution of the near term 775 Put is given by:

$$\frac{Δ {K}_{775 Put}}{{K}_{775 Put}^{2}} {e}^{{RT}_{1}} Q ( 775 Put )$$

Generally, ΔKᵢ is half the distance between the strike on either side of Kᵢ; but at the upper and lower edges if any given strip of options, ΔKᵢ is simply the difference between Kᵢ and the adjacent strike price. In this example index, 775 is the lowest strike in the strip of near term options and 800 happens to be the adjacent strike. Therefore,

$$Δ {K}_{775 Put} = 25 ( 800 - 775 ) , \\ and$$

$$\frac{Δ {K}_{775 Put}}{{K}_{775 Put}^{2}} {e}^{{RT}_{1}} Q ( 775 Put ) = \frac{25}{{775}^{2}} {e}^{01162 ( 0.041095890 )} ( 0.11 ) = 0.000005$$

A similar calculation is performed for each option. The resulting values for the near terms options are then summed and multiplied by 2/T₁. Likewise, the resulting values for the next term options are summed and multiplied by 2/T₂. Table 3 summarizes the results for each strip of options:

TABLE 3
Results for Strip of Options in the Example Index

| Near | | Mid- | Contri- | Near | | Mid- | Contri- |
|---|---|---|---|---|---|---|---|
| term | Option | quote | bution | term | Option | quote | bution |
| Strike | Type | Price | by Strike | Strike | Type | Price | by Strike |
| 775 | Put | 0.11 | 0.000005 | 775 | Put | 2.72 | 0.000113 |
| 800 | Put | 0.41 | 0.000016 | 800 | Put | 4.76 | 0.000186 |
| 825 | Put | 1.30 | 0.000048 | 825 | Put | 8.01 | 0.000295 |
| 850 | Put | 3.60 | 0.000125 | 850 | Put | 12.97 | 0.000449 |
| 875 | Put | 8.64 | 0.000282 | 875 | Put | 20.18 | 0.000660 |
| 900 | Put/Call | 18.19 | 0.000562 | 900 | Put/ | 30.78 | 0.000951 |
| | Average | | | | Call | | |
| | | | | | Average | | |
| 925 | Call | 8.07 | 0.000236 | 925 | Call | 19.57 | 0.000573 |
| 950 | Call | 2.68 | 0.000074 | 950 | Call | 11.00 | 0.000305 |
| 975 | Call | 0.62 | 0.000016 | 975 | Call | 5.43 | 0.000143 |
| 1000 | Call | 0.09 | 0.000002 | 1000 | Call | 2.28 | 0.000057 |
| 1025 | Call | 0.01 | 0.000000 | 1025 | Call | 0.78 | 0.000019 |

| | | |
|---|---|---|
| $\frac{2}{T} {\sum }_{i} \frac{Δ {K}_{i}}{{K}_{i}^{2}} {e}^{RT} Q ( {K}_{i} )$ | 0.066478 | 0.063683 |

Next,

$${\frac{1}{T} [ \frac{F}{{K}_{0}} - 1 ]}^{2}$$

is calculated for the near term (T₁) and next term (T₂):

$$\begin{matrix}{\frac{1}{{T}_{1}} [ \frac{{F}_{1}}{{K}_{0}} - 1 ]}^{2} = {\frac{1}{0.041095890} [ \frac{900.43}{900} - 1 ]}^{2} \\ = 0.000006 \\ {\frac{1}{{T}_{2}} [ \frac{{F}_{2}}{{K}_{0}} - 1 ]}^{2} = {\frac{1}{0.117808219} [ \frac{901.23}{900} - 1 ]}^{2} \\ = 0.000016\end{matrix}$$

Then, σ₁² and σ₂² are calculated:

$$\begin{matrix}{σ}_{1}^{2} = \frac{2}{{T}_{1}} {\sum }_{i} \frac{Δ {K}_{i}}{{K}_{i}^{2}} {e}^{{RT}_{1}} Q ( {K}_{i} ) - {\frac{1}{{T}_{1}} [ \frac{{F}_{1}}{{K}_{0}} - 1 ]}^{2} \\ = 0.066478 - 0.000006 \\ = 0.066472 \\ {σ}_{2}^{2} = \frac{2}{{T}_{2}} {\sum }_{i} \frac{Δ {K}_{i}}{{K}_{i}^{2}} {e}^{{RT}_{2}} Q ( {K}_{i} ) - {\frac{1}{{T}_{2}} [ \frac{{F}_{2}}{{K}_{0}} - 1 ]}^{2} \\ = 0.063683 - 0.000016 \\ = 0.063667\end{matrix}$$

Third, σ₁² and σ₂² are interpolated to arrive at a single value with a constant maturity of 30 days to expiration:

$$σ = \sqrt{\{ {T}_{1} {σ}_{1}^{2} [ \frac{{N}_{{T}_{2}} - {N}_{30}}{{N}_{{T}_{2}} - {N}_{{T}_{1}}} ] + {T}_{2} {σ}_{2}^{2} [ \frac{{N}_{30} - {N}_{{T}_{1}}}{{N}_{{T}_{2}} - {N}_{{T}_{1}}} ] \} \times \frac{{N}_{365}}{{N}_{30}}}$$

where:

N_{T1} is the number of minutes to expiration of the near term options (21,600);

N_{T2} is the number of minutes to expiration of the next term options (61,920);

N₃₀ is the number of minutes in 30 days (43,200); and

N₃₆₅ is the number of minutes in a 365 day year (525,600). Thus,

$$\begin{matrix}σ = \sqrt{\{ \begin{matrix}( \frac{21 , 600}{525 , 600} ) \times 0.066472 \times [ \frac{61 , 920 - 43 , 200}{61 , 920 - 21 , 600} ] + \\ ( \frac{61 , 920}{525 , 600} ) \times 0.0063667 \times [ \frac{43 , 200 - 21 , 600}{61 , 920 - 21 , 600} ]\end{matrix} \} \times \frac{525 , 600}{43 , 200}} \\ = σ \\ = 0.253610\end{matrix}$$

This value is multiplied by 100 to get the example volatility index in accordance with the principles of the present invention of 25.36.

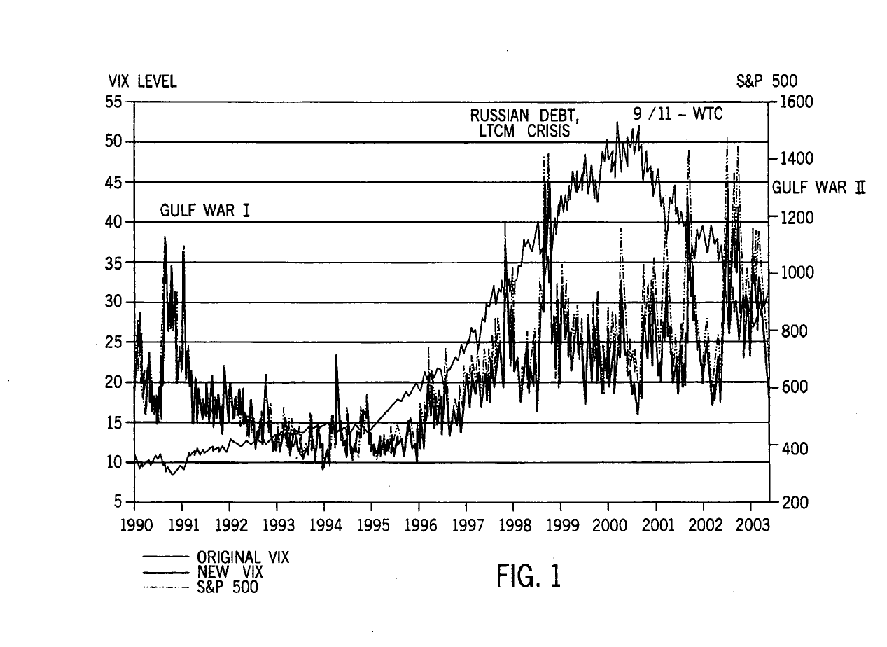

FIG. 1 is a graph illustrating the prior art VIX® index, the S&P 500® index, and the example index of the present invention from January 1998 through April 2003. The spike in the volatility indexes that occurred after August 1998 resulted from the Long Term Capital Management and the Russian debt crises; the spike that occurred after September 2001 resulted from the World Trade Center terrorism; the volatility that occurred after July 2002 reflects the ongoing Iraq crisis.

FIG. 1 demonstrates that the volatility index of the present invention incorporates the improved features of estimating expected volatility from a broader sampling then just at-the-money strikes, not relying on the Black/Scholes or any other option pricing model, and utilizing a broader market sampling without losing the fundamental measure of the market's expectation of volatility.

Table 4 provides an annual comparison of the example index of the present invention and the prior art VIX® index:

TABLE 4
Comparison of Example Index and Prior Art VIX ® Index

| | |
|---|---|
| Prior Art | Example |
| VIX | Index |

| Year | High | Low | High | Low |
|---|---|---|---|---|
| 1990 | 38.07 | 15.92 | 36.47 | 14.72 |
| 1991 | 36.93 | 13.93 | 36.20 | 13.95 |
| 1992 | 21.12 | 11.98 | 20.51 | 11.51 |
| 1993 | 16.90 | 9.04 | 17.30 | 9.31 |
| 1994 | 22.50 | 9.59 | 23.87 | 9.94 |
| 1995 | 15.72 | 10.49 | 15.74 | 10.36 |
| 1996 | 24.43 | 12.74 | 21.99 | 12.00 |
| 1997 | 39.96 | 18.55 | 38.20 | 17.09 |
| 1998 | 48.56 | 16.88 | 45.74 | 16.23 |
| 1999 | 34.74 | 18.13 | 32.98 | 17.42 |
| 2000 | 39.33 | 18.23 | 33.49 | 16.53 |
| 2001 | 49.04 | 20.29 | 43.74 | 18.76 |
| 2002 | 50.48 | 19.25 | 45.08 | 17.40 |
| 2003 through | 39.77 | 19.23 | 34.69 | 17.75 |
| August | | | | |

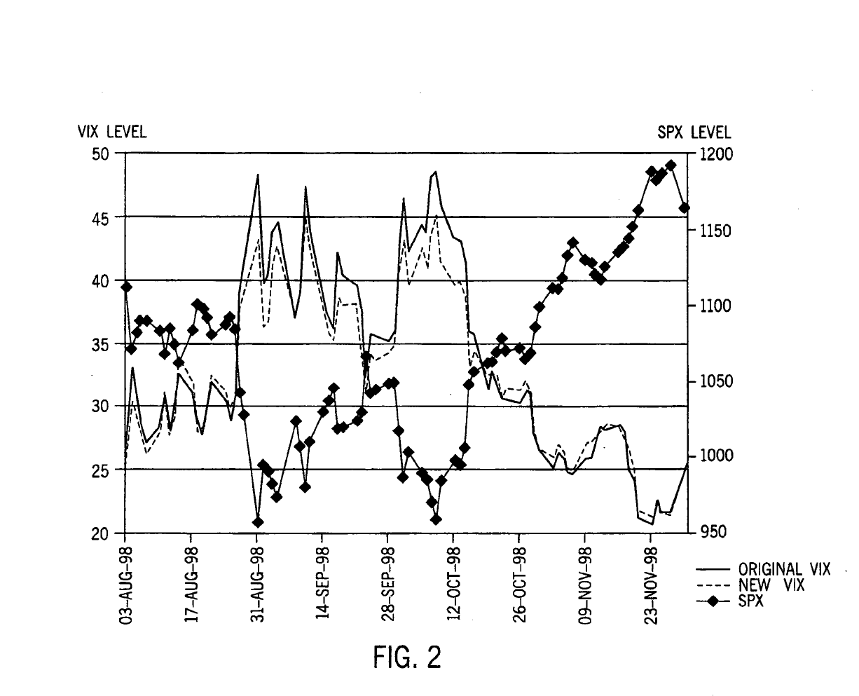

One of the most valuable features of the prior art VIX® index, and the reason it has been dubbed the “investor fear gauge,” is that, historically, the prior art VIX® index hits its highest levels during times of financial turmoil and investor fear. As markets recover and investor fear subsides, the prior art VIX® index levels tend to drop. This effect can be seen in the prior art VIX® index behavior isolated during the Long Term Capital Management and Russian Debt Crises in 1998. As FIG. 2 illustrates, the example index of the present invention mirrored the peaks and troughs of the prior art VIX® index as the market suffered through steep declines in August and October 1998, and then enjoyed a substantial rally through the end of November.

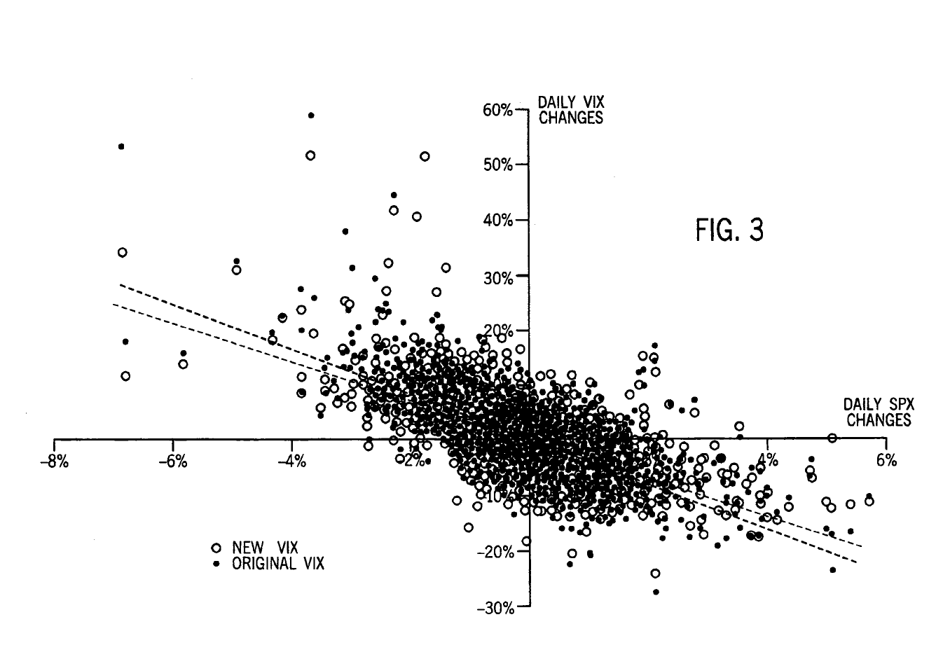

Another important aspect of the prior art VIX® index is that, historically, the prior art VIX® index tends to move opposite its underlying index. This tendency is illustrated in FIG. 3 comparing daily changes in both the example index of the present invention and the prior art VIX® index, with daily changes in the S&P 500® index. The scatter diagram for the prior art VIX® index is almost identical to that for the example index of the present invention. Also note that the negatively sloping trend line in both cases confirms the negative correlation with market movement.

Thus, the volatility index of the present invention, with its many enhancements, has retained the essential properties that made the prior art VIX® index the most popular and widely followed market volatility indicator for the past 10 years. The volatility index of the present invention is still the “investor fear gauge”, but is made better by incorporating the latest advances in financial theory and practice. The volatility index of the present invention paves the way for both listed and over-the-counter volatility derivative contracts at a time of increased market demand for such products.

In accordance with another aspect of the present invention, derivative contracts based on the volatility index of the present invention are provided. In a preferred embodiment, the derivative contracts comprise futures and options contracts based on the volatility index of the present invention. As known in the art, derivative contracts in accordance with the principals of the present invention are preferably embodied as a system cooperating with computer hardware components, and as a computer implemented method.

### Example Contract

The following is a non-limiting illustrative example of a financial instrument in accordance with the principles of the present invention.

In accordance with the principles of the present invention, a financial instrument in the form of a derivative contract based on the volatility index of the present invention is provided. In a preferred embodiment, the derivative contract comprises a futures contract. The futures contract can track the level of an “increased-value index” (VBI) which is larger than the volatility index. In a preferred embodiment, the VBI is ten times the value of volatility index while the contract size is $100 times the VBI. Two near-term contract months plus two contract months on the February quarterly cycle (February, May, August and November) can be provided. The minimum price intervals/dollar value per tick is 0.10 of one VBI point, equal to $10.00 per contract.

The eligible size for an original order that may be entered for a cross trade with another original order is one contract. The request for quote response period for the request for quote required to be sent before the initiation of a cross trade is five seconds. Following the request for quote response period, the trading privilege holder or authorized trader, as applicable, must expose to the market for at least five seconds at least one of the original orders that it intends to cross.

The minimum block trade quantity for the VIX futures contract is 100 contracts. If the block trade is executed as a spread or a combination, one leg must meet the minimum block trade quantity and the other leg(s) must have a contract size that is reasonably related to the leg meeting the minimum block trade quantity.

The last trading day is the Tuesday prior to the third Friday of the expiring month. The minimum speculative margin requirements for VIX futures are: Initial—$3,750, Maintenance—$3,000. The minimum margin requirements for VIX futures calendar spreads are: Initial—$50, Maintenance—$40. The reportable position level is 25 contracts. The final settlement date is the Wednesday prior to the third Friday of the expiring month.

The contracts are cash settled. The final settlement is 10 times a Special Opening Quotation (SOQ) of the volatility index calculated from the options used to calculate the index on the settlement date. The opening price for any series in which there is no trade shall be the average of that option's bid price and ask price as determined at the opening of trading. The final settlement price will be rounded to the nearest 0.01.

The Special Opening Quotation (SOQ) of the volatility index is calculated using the following procedure: The opening traded price, if any, and the first bid/ask quote is collected for each eligible option series. The forward index level, F, is determined for each eligible contract month based on at-the-money option prices. The at-the-money strike is the strike price at which the difference between the call and put mid-quote prices is smallest. The strike price immediately below the forward index level, K₀, is determined for each eligible contract month. All of the options are sorted in ascending order by strike price. Call options that have strike prices greater than K₀ and a non-zero bid price are selected, beginning with the strike price closest to K₀ and moving to the next higher strike prices in succession.

After two consecutive calls with a bid price of zero are encountered, no other calls are selected. Next, put options that have strike prices less than K₀ and a non-zero bid price are selected, beginning with the strike price closest to K₀ and then moving to the next lower strike prices in succession. After encountering two consecutive puts with a bid price of zero, no other puts are selected. Both the put and call with strike price K₀ are selected. The SOQ is calculated using the options selected. The price of each option used in the calculation is the opening traded price of that option. In the event that there is no opening traded price for an option, the price used in the calculation is the average of the first bid/ask quote for that option. The SOQ is multiplied by 10 in order to determine the final settlement price.

While the invention has been described with specific embodiments, other alternatives, modifications and variations will be apparent to those skilled in the art. All such alternatives, modifications and variations are intended to be included within the spirit and scope of the appended claims.

What is claimed is:

1. A computer implemented method of estimating expected volatility in financial markets comprising:
averaging weighted prices of out-of-the money put and call options based on a financial instrument; and
determining average weighted prices of out-of-the money put and call options in accordance with:
$${σ}^{2} = \frac{2}{T} {\sum }_{i} \frac{Δ {K}_{i}}{{K}_{i}^{2}} {e}^{RT} Q ( {K}_{i} ) - {\frac{1}{T} [ \frac{F}{{K}_{0}} - 1 ]}^{2}$$
where:
T is a time to expiration;
F is a forward index level;
Kᵢ is a strike price of i^{th} out-of-the-money option—a call if Kᵢ>F and a put if Kᵢ<F;
ΔKᵢ is an interval between strike prices:
K₀ is a first strike below the forward index level, F;
R is a risk-free interest rate to expiration; and
Q(Kᵢ) is a midpoint of a bid-ask spread for each option with strike Kᵢ.

2. The computer implemented method of estimating expected volatility in financial markets of claim 1 further wherein the time to expiration is calculated in minutes.

3. The computer implemented method of estimating expected volatility in financial markets of claim 2 further wherein the time to expiration T is calculated in accordance with the following:
$$T = \frac{\{ {M}_{Current day} + {M}_{Settlement day} + {M}_{Other days} \}}{Minutes in a year}$$
where:
M_{Current day} is the number of minutes remaining until midnight of the current day;
M_{Settlement day} is the number of minutes from midnight until the target time on the settlement day; and
M_{Other days} is the Total number of minutes in the days between current day and settlement day.

4. The computer implemented method of estimating expected volatility in financial markets of claim 1 further including determining a forward index level based on at-the-money option prices and selecting out-of-the-money call options that have a strike price greater than the forward index level.

5. The computer implemented method of estimating expected volatility in financial markets of claim 1 further including determining a forward index level based on at-the-money option prices and selecting out-of-the-money put options that have a strike price less than the forward index level.

6. The computer implemented method of estimating expected volatility in financial markets of claim 1 further including determining a forward index level based on at-the-money option prices and adding both put and call options with strike prices equal to a strike price immediately below the forward index level.

7. The computer implemented method of estimating expected volatility in financial markets of claim 1 further including using options that have non-zero bid prices.

8. The computer implemented method of estimating expected volatility in financial markets of claim 7 further including determining a forward index level based on at-the-money option prices and selecting options that have a strike price greater than the forward index level.

9. The computer implemented method of estimating expected volatility in financial markets of claim 7 further including determining a forward index level based on at-the-money option prices and selecting options that have a strike price less than the forward index level.

10. The computer implemented method of estimating expected volatility in financial markets of claim 7 further including determining a forward index level based on at-the-money option prices and adding options with strike prices equal to a strike price immediately below the forward index level.

11. A computer readable medium comprising computer executable code for estimating expected volatility in financial markets, the computer executable code comprising instructions for:
selecting a series of options with different expiration dates;
for a time period, determining a forward index level based on at-the-money option prices;
determining a forward index level for near and future term options;
determining a strike price immediately below the forward index level;
averaging quoted bid-ask prices for each option;
calculating volatility of the near and future term options; and interpolating the near and future term options volatility to arrive at a single value.

12. The computer readable medium of claim 11 wherein the future term options are next term options.

13. The computer readable medium of claim 12 further comprising instructions for selecting put and call options.

14. The computer readable medium of claim 13 further comprising instructions for selecting out-of-the-money call options that have a strike price greater than the forward index level.

15. The computer readable medium of claim 13 further comprising instructions for selecting out-of-the-money put options that have a strike price less than the forward index level.

16. The computer readable medium of claim 13 further comprising instructions for adding both put and call options with strike prices equal to a strike price immediately below the forward index level.

17. The computer readable medium of claim 11 further comprising instructions for centering the options around a strike price immediately below the forward index level.

18. The computer readable medium of claim 17 wherein the centering comprises selecting two options at the strike price immediately below the forward index level.

19. The computer readable medium of claim 18 further comprising instructions for averaging the put and call prices at the strike price immediately below the forward index level to arrive at a single value.

20. The computer readable medium of claim 17 wherein the centering comprises selecting a single option, either a put or a call, for every other strike price.
